(19) United States
(12) Patent Application Publication
(10) Pub. No.: US 2006/0201561 A1
(43) Pub. Date: Sep. 14, 2006

(54) Spout for providing tranquil fluid flow

(76) Inventors: Richard Dale Clift, Elyria, OH (US); Vrushant Fattesing Jagtap, North Olmsted, OH (US); Doug Kemp, North Ridgeville, OH (US); Stephen R. Norgrove, Wadsworth, OH (US)

Correspondence Address: CALFEE HALTER & GRISWOLD, LLP, 800 SUPERIOR AVENUE, SUITE 1400, CLEVELAND, OH, 44114, US

(21) Appl. No.: 11/078,809

(22) Filed: Mar. 11, 2005

(51) Int. Cl. F16K 21/00

(52) U.S. Cl. 137/801

(57) ABSTRACT

In one embodiment, a spout which provides a tranquil fluid flow is provided. The spout has a base and a trough attached to the top of and substantially perpendicular to the base. The base has a flow restrictor to reduce the flow rate of the fluid flowing from the base into the trough. The trough has an open design and a flow control disposed on its upper interior surface. The tip end of the trough is angled back towards the base. The spout allows fluid to flow out of the trough in a laminar flow state which results in a pleasant look and feel.

### BACKGROUND

The invention relates to a spout for a faucet and more specifically to an open spout designed to provide a tranquil fluid flow while conserving the amount of fluid dispensed.

Faucets are commonly used in kitchens and bathrooms to provide water to allow a user to perform daily tasks such as washing the user's hands or filling a bath tub. As with many products, users enjoy an aesthetically pleasing look not only to the faucet but also to the manner in which the water flows from the spout. Similarly, users enjoy a pleasant and relaxing “feel” when the water flowing from the spout is contacted by the user.

Generally, spouts provide a conduit for water to flow from a water supply pipe to a bath tub or sink. Often, the tip end of the spout is provided with an aerator and water straightener to direct the water flow into the sink or tub. However, aerators generally produce turbulence in the water flow which produces an unpleasant look and feel to the water as it flows from the spout. Furthermore, water straighteners increase the speed of the out-flowing water, thereby causing an unpleasant and harsh feel.

To produce a more aesthetically pleasing spout look, some spout designers have provided an “open” spout design. The open spout design removes the top surface of the spout, several inches before the spout tip, so that the water can be seen flowing within the spout prior to flowing over the lower surface of the spout tip into the bath tub or sink. Such a design eliminates the use of an aerator and water straightener, and generally provides a more pleasing spout look and water flow.

However, while using an open spout design may eliminate the turbulence associated with the aerator and water straightener, removing these items alone does not cure the unpleasant look and feel of the water flow. The water provided to the spout is at an elevated pressure. The elevated pressure also causes an unpleasant feel and also produces turbulence in the water flow which results in an unpleasant look and feel.

### SUMMARY

To provide a tranquil fluid flow, an open spout design having a flow control is provided. In one embodiment, an open design spout comprises a base and a trough. Water flows vertically upward through a conduit in the base to the trough which is disposed on top of the base. The trough is generally a hollow conduit having an opening at one end. The trough is oriented substantially perpendicular to the base and has its top surface removed several inches before a trough tip to provide the “open” design. The trough attaches to a stem of the base which has at least one outlet port to allow water to flow from the base into the trough.

The trough is secured to the base by a cap. Within the stem, a retaining screw having a flow restrictor is attached. The flow restrictor is disposed within a lower end of the retaining screw.

In practice, water from a water supply pipe flows into the conduit in the base. The water travels upwards in the conduit until it reaches the flow restrictor located at the lower end of the retaining screw. The flow restrictor, as the name suggests, restricts the flow of water that flows up through the retaining screw and out of the outlet port(s) located in the stem of the base. The water flowing from the outlet port(s) of the stem floods an internal cavity of the trough, located around the stem, and begins to flow towards the open end of the trough. At this point, the flow of the water is controlled by a flow control which protrudes from an upper interior surface of the trough. The flow control creates a smooth laminar flow along a lower interior surface of the trough. The water, in its laminar flow state, then continues down the trough until it reaches the trough tip, at which point, the water smoothly flows over the tip into the sink or tub. The trough tip is angled such that a lower portion is closer to the base than an upper portion. Since the water flowing over the trough tip is in a smooth laminar flow state, the water has a pleasant look and feel, even at maximum flow rate.

Numerous other advantages and features of the present invention will become readily apparent from the following detailed description of the invention and the embodiments thereof, from the claims and from the accompanying drawings.

### BRIEF DESCRIPTION OF THE DRAWINGS

The invention as well as embodiments and advantages thereof are described below in greater detail, by way of example, with reference to the drawings in which:

FIG. 1 is a side elevational view of the spout in accordance with one embodiment of the present invention;

FIG. 2 is an exploded perspective view of the spout in accordance with the embodiment of FIG. 1;

FIG. 3 is a cross-sectional side view of the spout in accordance with the embodiment of FIG. 1; and

FIG. 4 is a front elevational view of the trough of the spout in accordance with the embodiment of FIG. 1.

### DETAILED DESCRIPTION

While this invention is susceptible of embodiment in many different forms, there are shown in the drawings and will be described herein in detail specific embodiments thereof with the understanding that the present disclosure is to be considered as an exemplification of the principles of the invention and is not intended to limit the invention to the specific embodiments illustrated.

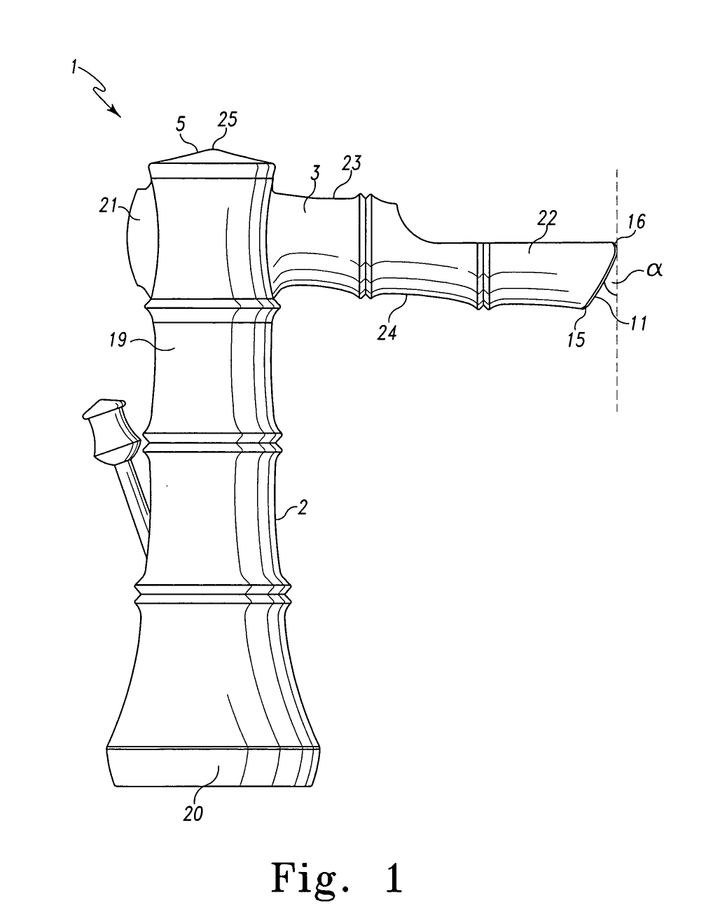

Referring to FIG. 1, a spout 1 in accordance with one embodiment is illustrated. The spout 1 includes a base 2, a trough 3, and a cap 5. The base 2 is substantially vertical. The trough 3 lies substantially horizontal and substantially perpendicular to the base 2. The base 2 includes an upper end 19 and a lower end 20. The trough 3 includes a closed end 21 and an open end 22. The trough 3 also includes an upper portion 23 and a lower portion 24. The open end 22 of the trough 3 has a trough tip 11.

In one embodiment, the closed end 21 of the trough 3 encloses the upper end 19 of the base 2. The open end 22 of the trough 3 has the upper portion 23 of the trough 3 removed to allow a user to view the water as it flows down the trough 3 and over the trough tip 11 into the sink or tub.

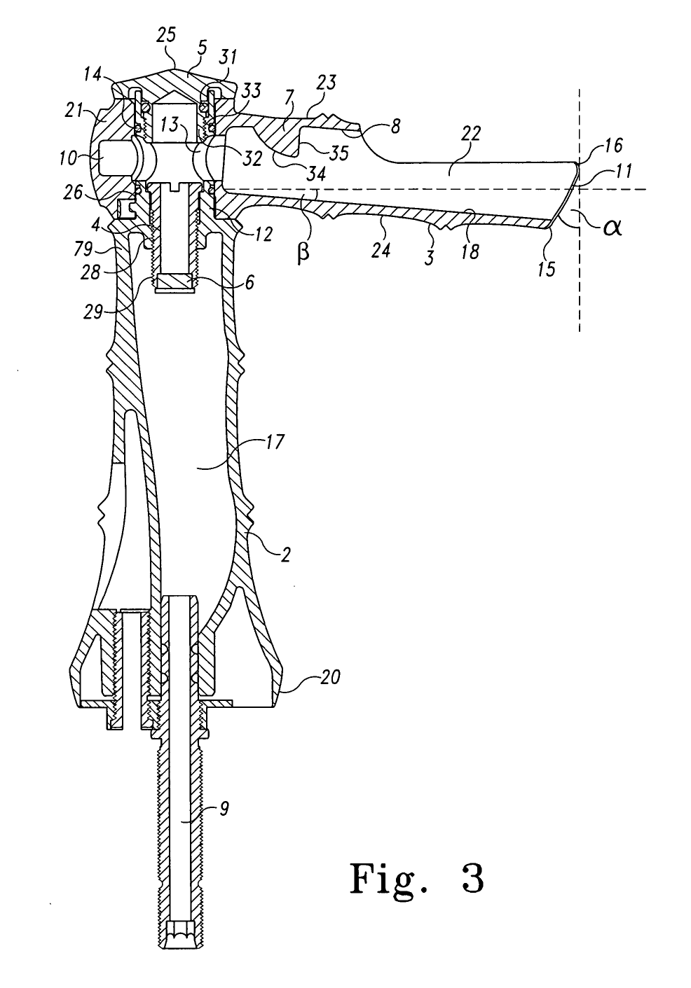

The trough tip 11 has an upper tip portion 16 and a lower tip portion 15. The trough tip 11 is angled such that the lower tip portion 15 is closer to the base 2 than the upper tip portion 16. The angle of the tip 11 may vary so long as the lower tip portion 15 is closer to the base 2 than the upper tip portion 16. In one embodiment, the tip 11 forms a tip angle α of at least 30 degrees with respect to a vertical line X (shown as a dashed line in FIGS. 1 and 3).

The base 2 and trough 3 may have an ornamental outer design/color and may be made from a variety of materials, including but not limited to plastic, steel, iron, or any other metal or material. Similarly, the height of the base 2 and length of the trough 3 may vary. In one embodiment, the base 2 is approximately 6 inches as measured from the lower end 20 of the base 2 to the lower portion 24 of the trough 3, and the trough 3 is approximately 5 inches as measured from a center 25 of the cap 5 to the upper tip portion 16.

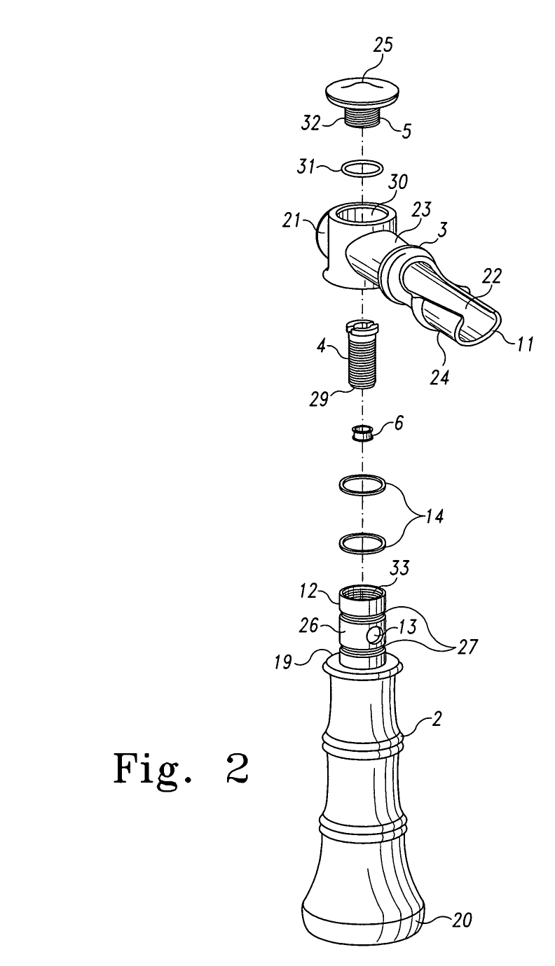

Referring to FIG. 2, an exploded view of the spout 1 of FIG. 1 is shown to explain the method of assembling the spout 1. As shown therein, the base 2 has a stem 12 protruding from the upper end thereof. The stem 12 has at least one outlet port 13 disposed therein. In one embodiment (as can be seen in FIG. 3), the stem 12 of the base 2 has two outlet ports 13 aligned axially with the trough 3. An outer surface 26 of the stem 12 has two grooves 27 located above and below the outlet ports 13 in which a pair of O-rings 14 are disposed. The O-rings 14 are used to seal the joint between the stem 12 and the trough 3 such that water is prevented from leaking from the joint areas. A tubular retaining screw 4 is screwed to a lower interior surface 28 of the stem 12 of the base 2. A flow restrictor 6 is disposed within a lower end 29 of the retaining screw 4. The placement, disposition and/or size of the flow restrictor are not limited in the present invention and may be adjusted to fit the particular spout 1 based on its intended use. However, in one embodiment, the flow is restricted to not more than 1.2 gallons per minute (GPM).

Over the stem 12, the trough 3 is placed. The outlet ports 13 of the stem 12 are aligned with an interior cavity 10 (see FIG. 3) of the trough 3. There is an opening in the upper portion 23 of the trough 3. A threaded portion 32 of the cap 5 is disposed within the opening 30 in the trough 3 and screwed into an upper interior surface 33 of the stem 12. By attaching the cap 5 to the stem 12 of the base 2, the cap 5 holds the trough 3 tightly in place with respect to the base 2. Furthermore, the O-ring 31 inserted within the cap 5 provides a water seal and prevents water from escaping between the opening 30 in the trough 3 and the cap 5. Although the trough 3 is attached to the base 2 using the cap 5, the present invention is not limited to such a manner of attachment. Other manners of attaching the trough 3 to the base 2, such as screwing the trough 3 directly to the stem 12 of the base 2 are within the scope of the present invention.

Referring to FIG. 3, the inner assembly of the water spout is illustrated. The lower end 20 of the base 2 is screwed to a water pipe 9. The water pipe 9 is generally attached to both a hot water supply pipe and a cold water supply pipe which are controlled via a control unit. The control unit (not shown) includes two control handles, one to control the hot water and one to control the cold water, that are operated by a user to determine the temperature of the water supplied through water pipe 9. The control unit also includes a mixing device (not shown) which combines the user controlled hot water supply and cold water supply to provide water to water pipe 9 at the user's desired temperature.

As water flows from the water pipe 9 into an interior chamber 17 of the base 2, the chamber 17 begins to fill and the water level rises. Once the water level rises to the top of the chamber 17, the water flows through the flow restrictor 6. The flow restrictor 6, which is disposed within the lower end 29 of the retaining screw 4, restricts the flow rate of the water such that the water flows at a slower rate. Depending on the particular spout, the flow rate can be adjusted, but in one embodiment, the flow rate is no more than 1.2 GPM.

The water, at the reduced flow rate, flows up through the retaining screw 4, into the stem 12 and out of the outlet ports 13. As stated previously, a plurality of outlet ports 13 may be disposed around the outer surface 26 of the stem 12, although only one is necessary to practice the present invention. The plurality of outlet ports 13 allows the water to exit the stem 12 more calmly, thereby reducing the turbulence in the water to provide a more aesthetically pleasing look and feel. When a plurality of outlet ports 13 is utilized, a cavity 10 may be provided within the trough 3 to surround the outlet ports 13.

The water, having reduced turbulence, exits the outlet ports 13, into the cavity 10 and flows towards the trough tip 11. While the combination of the flow restrictor 4, outlet ports 13 and cavity 10 reduces the turbulence in the water, the water may still have some turbulence as it exits the outlet ports 13, especially when the incoming water is at a maximum setting. In order to eliminate any remaining turbulence in the water and to provide a pleasant look and feel to the water, a flow control 7 is disposed on an upper interior surface 8 of the trough 3. The flow control 7 may be a monolithic protrusion from the upper interior surface 8 of the trough 3, or the flow control 7 may be discretely made and attached to the upper interior surface 8.

As the water exits the stem 12, often the water flows at a height within the trough 3 which is too great to flow in a laminar state. As a result, the flow control 7 is used to push the water downward and remove the remaining turbulence in the water so that the water flows in a laminar state towards the trough tip 11. In cross-section, the flow control 7 has a curved surface on the rear side 34 of the flow control 7 and a flat substantially vertical surface on the front side 35. The size and disposition of the flow control 7 on the upper interior surface 8 may be adjusted to meet the particular spout 1. In one embodiment, the flow control 7 is approximately one inch from the stem 12 of the base 2.

The water continues to gradually flow towards the trough tip 11. The speed at which the water flows down the trough 3 is further controlled by the trough angle β. The trough angle β is the angle of a lower interior surface 18 of the trough 3 relative to a horizontal line Y (shown as a dashed line in FIG. 3). In one embodiment, the trough angle β is approximately 3 degrees.

When the water reaches the trough tip 11 in a laminar state, it flows over lower tip portion 15 into the sink or tub. As previously stated, the tip angle α is such that the lower tip portion 15 is closer to the base 2 than the upper tip portion 16. The back-cut tip angle α allows the water to flow over the lower tip portion 15 and remain in a laminar state as it falls from the trough 3. By remaining in a laminar state, the look and feel of the water remains pleasant as the water falls into the sink or tub.

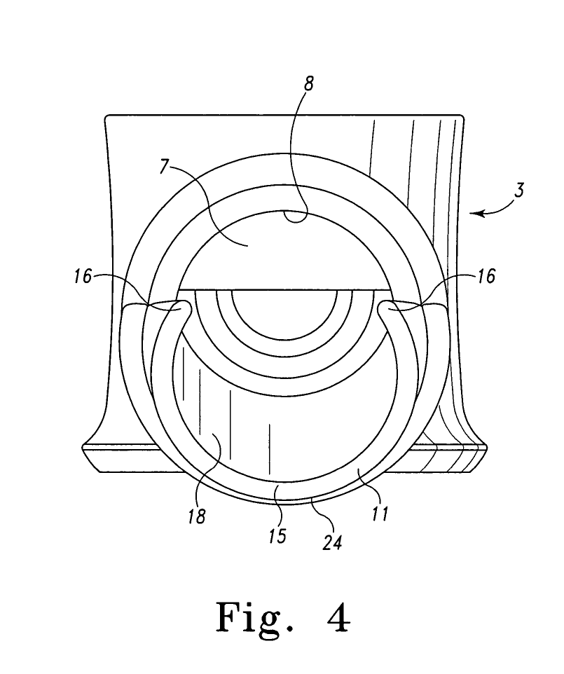

Referring to FIG. 4, the trough 3 is shown as viewed from the open end 22. As can be seen, the open end 22 of the trough 3 has a cross-sectional shape that is substantially circular, although the cross-sectional shape may vary depending on the aesthetical desires of the user. Also, the upper tip portion 16 of the trough tip 11 is compressed radially inward. This feature helps prevent the water from flowing around the upper tip portion 16 and onto the lower portion 24 of the trough 3. Depending on the maximum flow rate of the spout 1, the compression amount may vary.

The above description of specific embodiments has been given by way of example. From the disclosure given, those skilled in the art will not only understand the present invention and its attendant advantages, but will also find apparent various changes and modifications to the structures and methods disclosed. It is sought, therefore, to cover all such changes and modifications as fall within the spirit and scope of the invention, as defined by the appended claims, and equivalents thereof.

What is claimed is:

1. A spout comprising;
a base; and
a trough disposed on an upper end of said base,
wherein a flow control is disposed on an upper interior surface of said trough.

2. The spout of claim 1, wherein said spout is an open design.

3. The spout of claim 1, wherein said trough has a back-cut tip angle.

4. The spout of claim 1, wherein said flow control controls fluid flow such that said fluid flows in a laminar state from said trough.

5. The spout of claim 3, wherein said tip angle is at least 30 degrees.

6. The spout of claim 1, wherein said trough is angled downwardly.

7. The spout of claim 6, wherein said trough has a trough angle of about 3 degrees.

8. The spout of claim 1, wherein an upper tip portion of said trough is compressed radially inward relative to a lower tip portion of said trough.

9. The spout of claim 1, wherein said base has a stem with at least one outlet port disposed through said stem, and wherein said trough has a cavity that surrounds said at least one outlet port.

10. A faucet system comprising:
a spout having a base and a trough disposed on said base; and
a control handle,
wherein said trough has a flow control disposed on an upper interior surface of said trough.

11. The faucet system of claim 10, wherein said spout is an open design.

12. The faucet system of claim 10, wherein said flow control controls fluid flow such that said fluid flows in a laminar state from said trough.

13. The faucet system of claim 10, wherein said trough has a back-cut tip angle.

14. The faucet system of claim 13, wherein said tip angle is at least 30 degrees.

15. The faucet system of claim 10, wherein said trough is angled downwardly.

16. The faucet system of claim 15, wherein said trough has a trough angle of about 3 degrees.

17. The faucet system of claim 10, wherein an upper tip portion of said trough is compressed radially inward relative to a lower tip portion of said trough.

18. The faucet system of claim 10, wherein said base has a stem with at least one outlet port disposed through said stem, and wherein said trough has a cavity that surrounds said at least one outlet port.

19. A method of providing tranquil fluid from an open design spout comprising the steps of:
removing turbulence from the fluid such that the fluid flows in a laminar state using a flow control disposed on an upper interior surface of a trough of said spout.

20. The method of claim 19, wherein said trough has a back-cut tip angle.

21. The method of claim 21, wherein said tip angle is at least 30 degrees.
